(19) United States
(12) Patent Application Publication
(10) Pub. No.: US 2024/0388956 A1
(43) Pub. Date: Nov. 21, 2024

(54) DATA FLOWS FROM MULTIPLE DEVICES WITH JOINT QUALITY-OF-SERVICE REQUIREMENTS

(71) Applicants: Koninklijke KPN N.V., Rotterdam (NL); Nederlandse Organisatie Voor Toegepast-Natuurwetenscappelijk Onderzoek TNO, 's-Gravenhage (NL)

(72) Inventors: Kallol Das, Voorschoten (NL); Remco Litjens, Voorschoten (NL); Haibin Zhang, Voorburg (NL)

(21) Appl. No.: 18/690,207

(22) PCT Filed: Sep. 27, 2022
(86) PCT No.: PCT/EP2022/076876

§ 371 Date: Mar. 7, 2024

(30) Foreign Application Priority Data
Sep. 28, 2021 (EP) 21199337.3

(51) Int. Cl. H04W 28/02; H04L 47/625; H04W 72/1268; H04W 72/543

(52) U.S. Cl. CPC H04W 28/0263; H04L 47/6255; H04W 28/0215; H04W 72/1268; H04W 72/543

(57) ABSTRACT

A device (1) for transmitting data over a data radio bearer associated with a first data flow is configured to determine one or more quality-of-service requirements of one or more applications and create a request specifying the one or more quality-of-service requirements to admit a group of at least two data flows with one or more joint quality-of-service requirements. The group of data flows comprises the first data flow. The device is further configured to transmit (251) the request to a system (41) for establishing data flows. receive (257), from the system for establishing data flows, a response indicating whether the request has been accepted or rejected, and transmit (263) data to a base station (21) over the data radio bearer associated with the first data flow if the request has been accepted.

### FIELD OF THE INVENTION

The invention relates to a device for transmitting data over a data radio bearer associated with a first data flow, to a system for establishing data flows, and to a base station for allocating resources for transmitting data from a device to the base station over a data radio bearer associated with a data flow.

The invention further relates to a method of transmitting data over a data radio bearer associated with a first data flow, to a method of establishing data flows, and to a method of allocating resources for transmitting data from a device to a base station over a data radio bearer associated with a data flow.

The invention also relates to computer program products enabling a computer system to perform such methods.

### BACKGROUND OF THE INVENTION

The uplink throughput (or other performance metric, e.g., related to reliability) attainable in wireless networks is typically limited by the maximum transmit power of a UE (User Equipment). Even if more spectral resources may be available to assign to a given UE, a more generous spectral assignment (e.g., Physical Resource Blocks in a 4/5G system) implies that the UE's available transmit power is distributed over more PRBs (Physical Resource Blocks), and hence the consequent reduction of the per-PRB SINR (Signal to Interference plus Noise Ratio) and the correspondingly selected lower MCS (Modulation and Coding Scheme) counteract the attainable throughput gains (at least partially). Depending on the application-level use case or radio network conditions, in certain scenarios, it may be beneficial for a given (set of) application(s) to utilize the additional transmit power that becomes available when jointly utilizing multiple UEs.

In state-of-the-art technological implementations, a given UE operates in a solitary fashion, handling in up-and downlink whatever data traffic it is fed with by higher protocol layers, including the handling of traffic from one or more distinct applications. In case the UE's transmit power is a bottleneck such that the network is unable to support a given GBR (Guaranteed Bit Rate) requirement and/or other performance requirement for an uplink QoS (Quality of Service) flow maintained between the UE and its serving BS (Base Station) given the quality of the radio link, then there is effectively no uplink coverage for that bit rate and/or other performance requirement.

At the 3GPP RAN REL-18 workshop, which took place online from Jun. 28-Jul. 2, 2021, of which the documents have been published on https://www.3gpp.org/ftp/tsg_ran/TSG_RAN/TSGR_AHs/2021_06_RAN_Rel18_WS/, Rakuten Mobile proposed to “study the potential UE aggregation mechanism, including the architecture that can be utilized to aggregate UE's Tx Power to improve the UL throughput”. An increased available aggregate transmit power means that for a given PRB assignment, a higher per-PRB SINR can be achieved, a given per-PRB SINR target can be achieved on more PRBs, or some hybrid version of these effects. In all these cases, it may be possible to increase the attainable throughput. However, this does not mean that such higher throughput can be guaranteed.

### SUMMARY OF THE INVENTION

It is a first objective of the invention to provide systems and devices, which make it possible to admit and provide data flows with an uplink QoS requirement that would otherwise not be possible.

It is a second objective of the invention to provide methods, which make it possible to admit and provide data flows with an uplink QoS requirement that would otherwise not be possible.

In a first aspect of the invention, a device for transmitting data over a data radio bearer associated with a first data flow, comprises at least one processor configured to determine one or more quality-of-service requirements of one or more applications, create a request specifying the one or more quality-of-service requirements to admit a group of at least two data flows with one or more joint quality-of-service requirements, the group of data flows comprising the first data flow, transmit the request to a system for establishing data flows, receive, from the system for establishing data flows, a response indicating whether the request has been accepted or rejected, and transmit data to a base station over the data radio bearer associated with the first data flow if the request has been accepted.

For example, the request may specify a joint guaranteed bit rate requirement and/or a joint guaranteed latency requirement and/or a joint guaranteed reliability requirement.

By transmitting a request to admit a group of data flows with joint quality-of-service requirements on behalf of a group of devices, e.g., laptops, tablets, smartphones, IoT devices, surveillance cameras, medical equipment, and/or customer premises equipment, and establishing these data flows at a system for establishing data flows, the aggregated transmit power of this group of devices can be utilized to improve uplink throughput and/or other uplink performance aspects and data flows with uplink QoS requirements that would otherwise not be possible may be admitted and provided. Furthermore, this makes it possible to perform scheduling at the base station based on joint quality-of-service requirements rather than individual (data flow-specific) quality-of-service requirements.

The request may comprise device identifiers of devices in a group of devices, the group of devices comprising the device. Alternatively, the request may comprise a flag, the flag uniquely identifying the group of data flows and/or a group of devices. Preferably, each device will transmit a request and these requests will together be considered a joint request. Use of a flag uniquely identifying the group of data flows makes it possible for the system to determine which requests relate to the same group of data flows. Use of a flag that only identifies a group of devices but not the group of data flows has the benefit that the flag only needs to be shared once with the system when e.g., the devices of the group register to the system (e.g. the PCF). After the flag has been shared by the devices of the group, the system then stores the grouping information in a memory, e.g., as part of the subscription information. Based on this stored grouping information, all data flow requests from the group of devices may together be considered a joint admission request by the system, without the need for including a flag in the individual requests.

The request to admit the group of data flows may comprise a request to establish the first data flow. In this case, each device of the group may transmit a single request that is both a request to admit the group of data flows with the one or more joint quality-of-service requirements and a request to establish the data flow for the device transmitting the request. If the multiple requests from the multiple devices specify one or more different joint quality-of-service requirements, the multiple requests may all be rejected or a notification of non-matching requests may be issued. Alternatively, the at least one processor may be further configured to create a further request to establish the first data flow and transmit the further request to the system for establishing data flows before transmitting the data to the base station. Thus, the admission request and the establishment request transmitted by the device are separate requests in this case.

The system for establishing data flows may be, for example, part of the radio access network, e.g., the base station(s), or part of the core network, e.g., the Policy Control Function (PCF). The data flow may be a 5G QoS flow, for example.

In a second aspect of the invention, a system comprises the device and a further device, the further device being configured to transmit further data to the base station over a further data radio bearer associated with a second data flow, the group of data flows comprising the second data flow, wherein the system is configured to determine a size of a first queue associated with the first data flow, determine a size of a second queue associated with the second data flow, select a queue from a plurality of queues based on at least the sizes of the first queue and the second queue, the plurality of queues comprising the first queue and the second queue, and add a new data packet to the selected queue. When scheduling is performed at the base station based on one or more joint quality-of-service requirements, as will be described in more detail later in this specification, the system comprising the devices may be configured to take advantage of this new type of scheduling. When the system adds new data packets to only one of the queues (i.e. the data packets are not duplicated for reliability purposes), it is beneficial not to add the data packets to the queues alternately but to e.g., add each data packet to the queue which, based on the current buffer size and estimated/experienced depletion rate, would be emptied first, which typically is the queue of the data flow that experiences the highest throughput.

In a third aspect of the invention, a system for establishing data flows comprises at least one processor configured to receive, from a device, a request to admit a group of at least two data flows with one or more joint quality-of-service requirements, the request specifying the one or more joint quality of service requirements, determine whether the one or more joint quality-of-service requirements can be accepted, and transmit, to the device, a response that the request has been accepted if it is determined that the one or more joint quality-of-service requirements can be accepted or a response that the request has been rejected otherwise.

The at least one processor may be configured to determine one or more individual quality-of-service requirements for each of the devices in a group of devices based on the one or more joint quality-of-service requirements and ask the base station whether the base station can accept the individual quality-of-service requirements for the group of devices. This is beneficial if the base station is not aware of joint quality-of-service requirements. In this case, the base station will perform scheduling in a separate, per-flow manner.

The at least one processor may be configured to ask the base station whether the base station can accept the one or more joint quality-of-service requirements for the group of devices. This makes it easy to check whether a certain joint quality-of-service requirement is acceptable and makes it possible to perform scheduling at the base station based on one or more joint quality-of-service requirements rather than individual (data flow-specific) quality-of-service requirements.

The request to admit the group of data flows may comprise a request to establish a first data flow from the group of data flows and the at least one processor may be configured to establish the first data flow if it is determined that the one or more joint quality-of-service requirements can be accepted. In this case, each device of the group may transmit a single, combined request that is both a request to admit the group of data flows with the joint quality-of-service requirements (i.e., an admission request) and a request to establish the data flow for the device transmitting the request (i.e., an establishment request).

In a fourth aspect of the invention, a base station for allocating resources for transmitting data from a device to the base station over a data radio bearer associated with a data flow comprises at least one processor configured to receive a scheduling request from the device, the scheduling request requesting the base station to allocate resources for transmitting data from the device to the base station over the data radio bearer associated with the data flow, the data flow being associated with a group of at least two data flows for use by a group of devices, the group of data flows having been assigned one or more joint quality-of-service requirements, allocate the resources to the device based on the one or more joint quality-of-service requirements, and transmit a scheduling grant message to the device, the scheduling grant message informing the device of the allocated resources. The scheduler will have substantially more freedom when aiming for a single joint quality-of-service (e.g., GBR) requirement rather than multiple individual quality-of-service targets. This enhanced degree of freedom likely translates to diversity gains, hence improved spectral efficiency and hence cell capacity, which may in turn lead to an improved admission probability.

In a fifth aspect of the invention, a method of transmitting data over a data radio bearer associated with a data flow comprises determining one or more quality-of-service requirements of one or more applications, creating a request specifying the one or more quality-of-service requirements to admit a group of data flows with one or more joint quality-of-service requirements, the group of data flows comprising the first data flow, transmitting the request to a system for establishing data flows, receiving, from the system for establishing data flows, a response indicating whether the request has been accepted or rejected, and transmitting data to a base station over the data radio bearer associated with the first data flow if the request has been accepted. The method may be performed by software running on a programmable device. This software may be provided as a computer program product.

In a sixth aspect of the invention, a method of establishing data flows comprises receiving, from a device, a request to admit a group of data flows with one or more joint quality-of-service requirements, the request specifying the one or more joint quality of service requirements, determining whether the one or more joint quality-of-service requirements can be accepted, and transmitting, to the device, a response that the request has been accepted if it is determined that the one or more joint quality-of-service requirements can be accepted or a response that the request has been rejected otherwise. The method may be performed by software running on a programmable device. This software may be provided as a computer program product.

In a seventh aspect of the invention, a method of allocating resources for transmitting data from a device to a base station over a data radio bearer associated with a data flow comprises receiving a scheduling request from the device, the scheduling request requesting the base station to allocate resources for transmitting data from the device to the base station over the data radio bearer associated with the data flow, the data flow being associated with a group of at least two data flows for use by a group of devices, the group of at least two data flows having been assigned joint quality-of-service requirements, allocating the resources to the device based on the one or more joint quality-of-service requirements, and transmitting a scheduling grant message to the device, the scheduling grant message informing the device of the allocated resources. The method may be performed by software running on a programmable device. This software may be provided as a computer program product.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least a first software code portion, the first software code portion, when executed or processed by a computer, being configured to perform executable operations for transmitting data over a data radio bearer associated with a data flow.

The executable operations comprise determining one or more quality-of-service requirements of one or more applications, creating a request specifying the one or more quality-of-service requirements to admit a group of at least two data flows with one or more joint quality-of-service requirements, the group of data flows comprising the first data flow, transmitting the request to a system for establishing data flows, receiving, from the system for establishing data flows, a response indicating whether the request has been accepted or rejected, and transmitting data to a base station over the data radio bearer associated with the first data flow if the request has been accepted.

A non-transitory computer-readable storage medium stores at least a second software code portion, the second software code portion, when executed or processed by a computer, being configured to perform executable operations for establishing data flows.

The executable operations comprise receiving, from a device, a request to admit a group of at least two data flows with one or more joint quality-of-service requirements, the request specifying the one or more joint quality of service requirements, determining whether the one or more joint quality-of-service requirements can be accepted. and transmitting, to the device, a response that the request has been accepted if it is determined that the one or more joint quality-of-service requirements can be accepted or a response that the request has been rejected otherwise.

A non-transitory computer-readable storage medium stores at least a third software code portion, the third software code portion, when executed or processed by a computer, being configured to perform executable operations for allocating resources for transmitting data from a device to a base station over a data radio bearer associated with a data flow.

The executable operations comprise receiving a scheduling request from the device, the scheduling request requesting the base station to allocate resources for transmitting data from the device to the base station over the data radio bearer associated with the data flow, the data flow being associated with a group of at least two data flows for use by a group of devices, the group of data flows having been assigned one or more joint quality-of-service requirements, allocating the resources to the device based on the joint one or more quality-of-service requirements, and transmitting a scheduling grant message to the device, the scheduling grant message informing the device of the allocated resources.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including. but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java (TM), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s).

It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a flow diagram of an embodiment of the method of establishing data flows and an embodiment of the method of transmitting data over a data radio bearer associated with a data flow;

FIG. 2 is a flow diagram of an embodiment of the method of allocating resources for transmitting data over a data radio bearer associated with the data flow established in FIG. 1;

FIG. 3 is a block diagram of a first embodiment of the device and a first embodiment of the system;

FIG. 4 shows an example of a scenario in which the devices depicted in FIG. 3 may be used;

FIG. 5 shows an example of flows transmitted by the devices depicted in FIG. 3.

FIG. 6 is a block diagram of a second embodiment of the device and a second embodiment of the system in which the system is a base station;

FIG. 7 shows an example of flows transmitted by the devices depicted in FIG. 6;

FIG. 8 is a block diagram of the first embodiment of the device and a third embodiment of the system;

FIG. 9 shows an example of flows transmitted by the devices depicted in FIG. 8;

FIG. 10 is a block diagram of the first embodiment of the device, the first embodiment of the system, and a first embodiment of the base station;

FIG. 11 is a block diagram of the second embodiment of the device, a second embodiment of the base station, and a fourth embodiment of the system, in which the base station is the system; and

FIG. 12 is a block diagram of an exemplary data processing system for performing the methods of the invention.

Corresponding elements in the drawings are denoted by the same reference numeral.

### DETAILED DESCRIPTION OF THE DRAWINGS

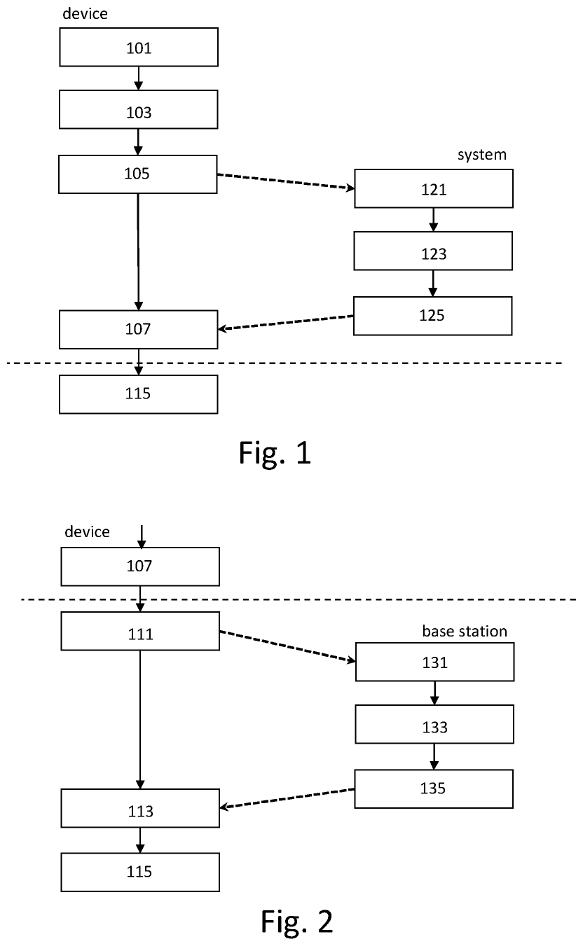

An embodiment of the method of transmitting data over a data radio bearer associated with a data flow and an embodiment of the method of establishing data flows is shown in FIG. 1

A step 101 comprises a device, e.g., a UE, determining one or more quality-of-service requirements of one or more applications. The device may receive these one or more quality-of-service requirements from a higher communication layer (in the device or in a system which comprises the device), for example. A step 103 comprises the device creating a request specifying the one or more quality-of-service requirements to admit a group of at least two data flows with joint quality-of-service requirements. The one or more joint quality-of-service requirements may comprise a joint guaranteed bit rate requirement and/or a joint guaranteed latency requirement and/or a joint guaranteed reliability requirement, for example. The group of data flows comprises a first data flow. A step 105 comprises the device transmitting the request to a system for establishing data flows.

A step 121 comprises the system receiving the request from the device. A step 123 comprises the system determining whether the one or more joint quality-of-service requirements can be accepted. A step 125 comprises the system transmitting, to the device, a response that the request has been accepted if it is determined that the one or more joint quality-of-service requirements can be accepted or a response that the request has been rejected otherwise.

A step 107 comprises the device receiving the response from the system. A step 115 comprises the device transmitting data to a base station over the data radio bearer associated with the first data flow if the request has been accepted. This base station may be the above-mentioned system, or this base station may be a different system.

An embodiment of the method of allocating resources for transmitting data from a device to a base station over a data radio bearer associated with a data flow is shown in FIG. 2. The second embodiment of FIG. 2 is an extension of the first embodiment of FIG. 1. In the embodiment of FIG. 2, steps 101-107 and steps 121-125 are performed as shown in FIG. 1.

Step 111 is performed after step 107. Step 111 comprises the device transmitting a scheduling request to the base station. The scheduling request requests the base station to allocate resources for transmitting data from the device to the base station over the data radio bearer associated with the (first) data flow.

Step 131 comprises the base station receiving the scheduling request from the device. As described above, the data flow is associated with a group of data flows for use by a group of devices and the group of data flows has been assigned one or more joint quality-of-service requirements. Step 133 comprises the base station allocating the resources to the device based on the one or more joint quality-of-service requirements. Step 135 comprises the base station transmitting a scheduling grant message to the device. The scheduling grant message informs the device of the allocated resources.

Step 113 comprises the device receiving the scheduling grant message from the base station. Step 115 comprises the device transmitting data to the base station over the data radio bearer associated with the (first) data flow using the allocated resources.

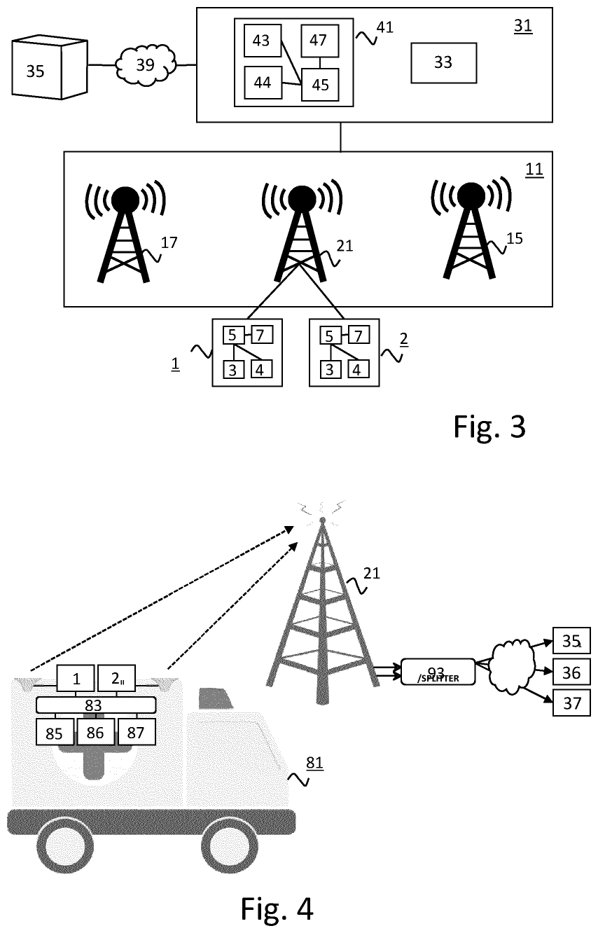

FIG. 3 is a block diagram of a first embodiment of the device for transmitting data over a data radio bearer associated with a first data flow and a first embodiment of the system for establishing data flows. The mobile communication network depicted in FIG. 3 comprises a radio access network (RAN) 11 and a core network (CN) 31. The RAN 11 comprises base stations 15, 17, and 21. The mobile communication network may be a 5G network, the RAN 11 may be a 5G New Radio RAN, and the base stations 15, 17, and 21 may be 5G gNodeB base stations, for example. Each of the base stations 15, 17, and 21 may comprise a plurality of distributed units that share a common centralized unit in a Centralized RAN (C-RAN) architecture. Two devices 1 and 2, e.g., 5G UEs, are connected to the base station 21.

The core network 31 comprises a system 41 for establishing data flows. The data flows may be QoS flows, for example. The core network 31 is connected to the Internet 39. An application server 35 is also connected to the Internet. The core network 31 further comprises a second core network system 33. The system 41 may implement the 5G Policy Charging Function (PCF), for example. The system 33 may implement the 5G User Plane Function (UPF), for example.

The devices 1 and 2 each comprise a receiver 3, a transmitter 4, a processor 5, and a memory 7. The processor 5 is configured to determine one or more quality-of-service requirements of one or more applications, e.g., at the (mobile) network level, and create a request to admit a group of at least two data flows with one or more joint quality-of-service requirements. The devices 1 and 2 may receive the one or more quality-of-service requirements of the one or more applications from a higher communication layer in a system which comprises the devices 1 and 2, for example.

The request specifies the one or more quality-of-service requirements of the one or more applications as the one or more joint quality-of-service requirements for which admission is requested. The group of data flows comprises the first data flow. The joint nature of the one or more quality-of-service requirements is clear from the request. An example of a joint quality-of-service requirement is a joint GBR requirement (e.g., 100 Mbit/s) for the group of data flows. The processor 5 is further configured to transmit the request to the system 41, receive, from the system 41, a response indicating whether the request has been accepted or rejected, and transmit data to the base station 21 over the data radio bearer associated with the first data flow if the request has been accepted.

The system 41 comprises a receiver 43, a transmitter 44, a processor 45, and a memory 47. The processor 45 is configured to receive, from the device 1 and/or the device 2, a request to admit a group of at least two data flows with one or more joint quality-of-service requirements. The request specifies the one or more joint quality-of-service requirements. The processor 45 is configured to determine whether the one or more joint quality-of-service requirements can be accepted, and transmit, to the device 1 and/or the device 2, a response that the request has been accepted if it is determined that the one or more joint quality-of-service requirements can be accepted or a response that the request has been rejected otherwise.

FIG. 4 shows an example of a scenario in which the devices depicted in FIG. 3 may be used. FIG. 4 depicts a scenario in which an ambulance 81 has an in-vehicle local area network served by an on-board access point which itself is attached to the two (distinct) devices 1 and 2, e.g., UEs, through which it connects to the base station 21 in the mobile communication network.

A splitter 83, functionally located between the application layer and the devices 1 and 2, can split the packet flows of one or more concurrently active applications, e.g., one or more of applications 85-87, over multiple devices, each of which maintaining a data flow (e.g., 5G QoS flow) with the mobile communication network through the base station 21. Each of the data flows has a queue to which data packets from the one or more applications are added.

An aggregator 93 resides in or beyond the RAN/core network in order to appropriately extract and aggregate the packet flows of the distinct applications as they are forwarded towards their respective destinations, i.e., application servers 35-37 corresponding to local applications 85-87. In this example, the splitter 83 and aggregator 93 reside outside of the mobile communication network, as is preferred. The devices 1 and 2 have their respective connections with the base station 21. Although FIG. 4 only shows two devices/UEs, more than two devices/UEs may be involved.

In the example of FIG. 4, the applications 85-87 may include one or more GBR-type applications, which are characterized by a minimum (guaranteed) bit rate requirement. In the ambulance scenario this may e.g., involve a real-time video conferencing or ultra-sound session between an ambulance-based paramedic and an expert doctor/surgeon on the hospital premises.

For example, a single GBR-type application may be active, and it may not be possible to satisfy the GBR requirement when the application's packet flow is handled by a single device/UE due to transmit power limitations. This could be because either the GBR requirement is rather demanding or the radio link between the device/UE and the base station is too weak. Either way, the combination of the assignable spectral resources and the device/UE's maximum transmit power cannot support the GBR required by the considered application. Traditionally, in such a scenario, the requested data flow would be rejected or the GBR request would be downgraded to a lower level. With the above-described device for transmitting data over a data radio bearer associated with a first data flow and above-described system for establishing data flows, this may be prevented.

Unlike for best-effort applications, just having an aggregator and a splitter on the two sides would not be sufficient for GBR applications. To see this, assume an application-level GBR of 100 Mb/s which somehow needs to be satisfied by the two disjunct data flows maintained by device 1 and device 2, respectively. Consider further that the quality and hence the supportable throughputs of the radio link between device 1 and base station 21 and the radio link between device 2 and base station 21 may differ, e.g., because the devices/UEs are installed in opposite corners of the ambulance 81 for diversity purposes.

Without any further measures, the distinct devices/UEs would have to somehow establish data flows with device/UE and data flow-specific GBR that sum up to the aggregate (application-level) GBR of 100 Mb/s. The splitter 83 has no clue whether that should be e.g., a 50/50, a 60/40 or a 70/30 split, since it does not know what kind of quality-of-service requirements the base station and the core network could admit. A 50/50 split could be attempted but it may very well be that the 50 Mb/s GBR request is admitted for one device/UE but not for the other, e.g., because the former has a stronger radio link. In that case, only the former data flow would be admitted and the aggregate GBR is 50+0=50 Mb/s, which is not good enough. It may very well be that in case of e.g., a 60/40 split, both data flows could be admitted, but as said, the splitter 83 has no way of knowing and an iterative trial-and-error approach is time-consuming and far from efficient.

With the solution described above, the devices/UEs request admittance of data flows with one or more joint quality-of-service requirements and do not need to request admittance of data flows with individual quality-of-service requirements, which would either result in lower admitted quality-of-service requirements or a time-consuming iterative trial-and-error approach. The above example has been given in relation to uplink throughput. However, the same techniques may be used to enhance other performance requirements, e.g., related to latency or reliability.

The solution may be implemented in several ways. The following is a non-exhaustive list of implementation options:
1. In implementation options 1a-c, the one or more joint quality-of-service requirements are split into individual (data flow-specific) quality-of-service requirements involving a procedure to determine/establish that split upon data flow establishment/modification. Once the split is made, the data flows are handled separately in terms of packet scheduling, i.e., in a conventional manner. The individual (data flow-specific) quality-of-service requirements are taken into account by the scheduler.
a) A system in the core network is requested to admit a group of at least two data flows with one or more joint quality-of-service requirements. This system checks whether these one or more joint quality-of-service requirements can be accepted by the core network and by the applicable base station(s). Thus, both the core network and the base station(s) are aware of the joint nature of the one or more quality-of-service requirements of the data flows. The system in the core network is in charge of determining the split. By also letting the base station(s) be aware of the joint nature of the one or more quality-of-service requirements of the data flows, the base station(s) can use this information to perform RAN admission control. The base station(s) may even propose a split. In any case, the base station(s) perform(s) scheduling in a separate, per-flow manner.
b) A base station is requested to admit a group of at least two data flows with one or more joint quality-of-service requirements. The base station is in charge of determining the split. The base station checks whether these individual quality-of-service requirements can be accepted by the core network and whether the base station itself can accept the one or more joint quality-of-service requirements. Alternatively, the base station may check whether it can accept the split individual quality-of-service requirements instead of the joint quality-of-service requirements. In this implementation option 1b, the core network is not aware of the joint nature of the one or more quality-of-service requirements of the data flows.
c) A system in the core network is requested to admit a group of at least two data flows with one or more joint quality-of-service requirements. This system checks whether the one or more joint quality-of-service requirements can be accepted by the core network, and determines a split and checks whether the corresponding individual quality-of-service requirements can be accepted by the applicable base station(s). The base station(s) are not aware of the joint nature of the one or more quality-of-service requirements of the data flows but the system may consult the base station(s) for one or more split options.
2. In implementation options 2a-b, the one or more joint quality-of-service requirements are managed only at the joint level. Since this not only affects admission control but in particular also packet scheduling, the base station needs to know the one or more joint quality-of-service requirements. One key advantage of implementation options 2a-b is that a channel-adaptive scheduler will have substantially more freedom when aiming for a single joint quality-of-service (e.g., GBR) target rather than multiple individual quality-of-service targets. This enhanced degree of freedom likely translates to diversity gains, hence improved spectral efficiency and hence cell capacity, which may in turn lead to an improved admission probability.
a) A system in the core network is requested to admit a group of at least two data flows with one or more joint quality-of-service requirements. Like in option 1a, the system checks whether these one or more joint quality-of-service requirements can be accepted by the core network and by the applicable base station(s). Thus, both the core network and the base station(s) are aware of the one or more joint nature of the quality-of-service requirements of the data flows. However, in option 2a, the scheduler of the base station uses the one or more joint quality-of-service requirements.
b) A base station is requested to admit a group of at least two data flows with one or more joint quality-of-service requirements. The base station checks whether the base station itself can accept the one or more joint quality-of-service requirements, and uses the one or more joint quality-of-service requirements if acceptable, but checks whether individual, rather than joint, quality-of-service requirements can be accepted by the core network. Thus, the core network is not aware of the joint nature of the one or more quality-of-service requirements of the data flows. The individual quality-of-service requirements are only created for the admissibility check with the core network (and possibly for traffic handling within the core network) and not used by the base station itself.

Thus, these implementations are distinct in (i) the awareness of the core network and/or the base station (RAN) regarding the joint nature of the one or more quality-of-service requirements of the data flows (option 1a/2a vs. option 1b/2b vs. option 1c); and (ii) whether the scheduler of the base station manages the quality-of-service requirements at the joint level (option 2a-b) or in an individual (data flow-specific) manner (options 1a-c).

In all the implementation options described above, a response is transmitted indicating that the request has been accepted. In all the implementation options described above, the devices may be served by different base stations. In implementation options 1a. 1c, 2a, and 2b, the different base stations would then normally need to coordinate for admission control of the joint QoS requirements and/or for joint QoS scheduling. If the devices are served by different distributed units of the same base station in a C-RAN architecture, the admission control of the joint QoS requirements and/or the joint QoS scheduling may be performed by the central unit, for example.

FIG. 3 represents implementation option 1a). This implementation option addresses the case where both the base station and the core network are aware of the joint nature of the data flows and scheduling is done in a separate, per-flow manner. In this option, the core network function manages the data flow establishment (In 5G, the PCF manages QoS flow establishment), informs the base station of the joint nature of the data flows, asks the base station for the (admissibility of the) joint quality-of-service requirements (e.g., for the optimal GBR split), checks admissibility from a core network perspective, and then admits (or rejects) and configures the data flows accordingly.

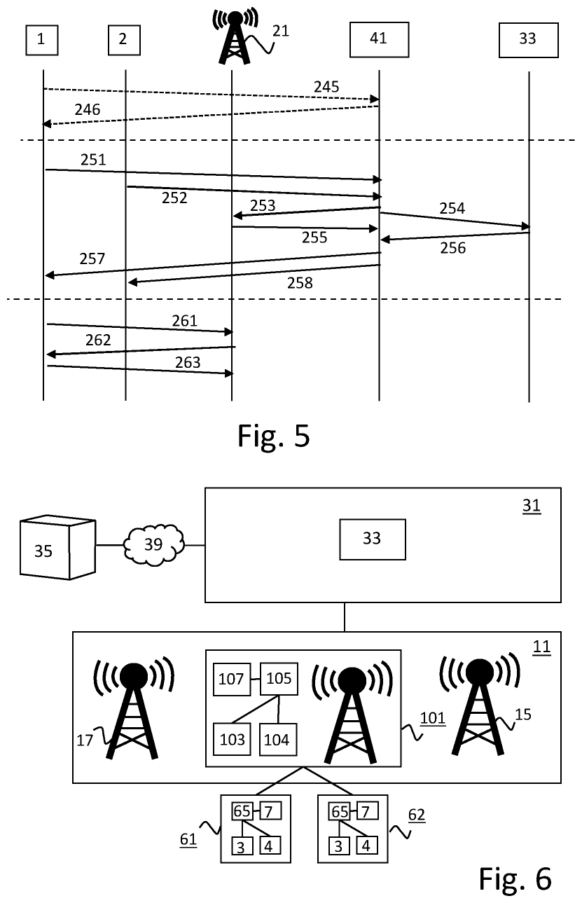

FIG. 5 shows an example of flows transmitted by the devices depicted in FIG. 3. In step 251, a request to admit a group of data flows (referred to as QoS flows in 5G) with one or more joint quality-of-service requirements is transmitted by the device 1 to the (core network) system 41. The request may comprise device identifiers of devices in a group of devices that comprises the device, for example. Alternatively, the request may comprise a flag which uniquely identifies the group of data flows, for example. If the request comprises such a flag, it may be obtained in optional steps 245 and 246 preceding step 251.

In step 245, the device 1 transmits a request for a flag to the system 41 upon receiving an instruction to do so by higher layer functionality, e.g., an instruction from the splitter 83 of FIG. 4 or from one of the applications 85-87 of FIG. 4. For example, the application 85 may be controlled by the application server 35 to instruct device 1 in this manner. In step 246, the system 41 transmits the flag to the device 1 in response to the request. The device 1 then passes the flag to the higher layer functionality, which can then provide it to devices 1 and 2.

In step 252, a similar request to admit the group of data flows with the one or more joint quality-of-service requirements is transmitted by the device 2 to the (core network) system 41. Steps 251 and 252 are not just requests to admit the group of data flows but also each comprise a request to establish a respective data flow. In an alternative embodiment, the request or requests to admit the group of data flows is/are separate from the requests to establish the respective data flows. If the request transmitted in step 251 is not the same as the request transmitted in step 252, i.e., specify different quality-of-service requirements, then both requests may be rejected or a notification of non-matching requests may be issued. In the case, steps 253-256 may be skipped.

In step 253, the system 41 asks the base station 21, for example via SMF signaling (the SMF is not depicted in FIG. 3), whether the base station can accept the one or more joint quality-of-service requirements for the group of devices. The system 41 identifies the devices of the group of devices in its message to the base station 21. In step 254, the system 41 asks the second system 33 in the core network via SMF signaling whether the core network can accept the one or more joint quality-of-service requirements.

Steps 253 and 254 are only performed after all requests to admit the group of data flows with the one or more joint quality-of-service requirements have been received by the system 41. If these requests comprise device identifiers of devices in the group of devices, then the system 41 may wait until requests have been received from these devices. However, the system 41 may use a maximum waiting time. This is especially beneficial if devices are able to establish multiple data flows. For example, requests may only be considered to relate to the same group of data flows if the requests are received at around the same time.

If the requests comprise a flag which uniquely identifies the group of data flows, then there is no need to use a maximum waiting time for distinguishing between requests relating to different groups of data flows. However, in order to check with the base station 21 whether the one or more joint quality-of-service requirements can be accepted, all the device identifiers need to be known. The system 41 therefore waits until all requests have been received by the system 41 before performing steps 253 and 254. If it cannot be determined from the flag how many requests will be transmitted, then a maximum waiting time is used. If this can be determined, it may still be beneficial to use a maximum waiting time. In both cases, the maximum waiting time might be made larger than if the requests do not comprise a flag unique for the group of data flows.

In step 255, the system 41 is informed by the base station 21 whether the base station 21 accepts the one or more joint quality-of-service requirements for the group of devices. In step 256, the system 41 is informed by the second system 33 whether the core network accepts the one or more joint quality-of-service requirements.

In steps 257 and 258, a response that the request has been accepted (if it is determined that the one or more joint quality-of-service requirements can be accepted) or a response that the request has been rejected is transmitted to the devices 1 and 2, respectively. The same response, i.e., acceptance or rejection, is transmitted to both devices. With steps 257 and 258, the respective data flows are established if it is determined that the one or more joint quality-of-service requirements can be accepted. If the request to admit the group of flows has been rejected, the devices may repeat steps 251 and 252 with one or more reduced joint quality-of-service requirements.

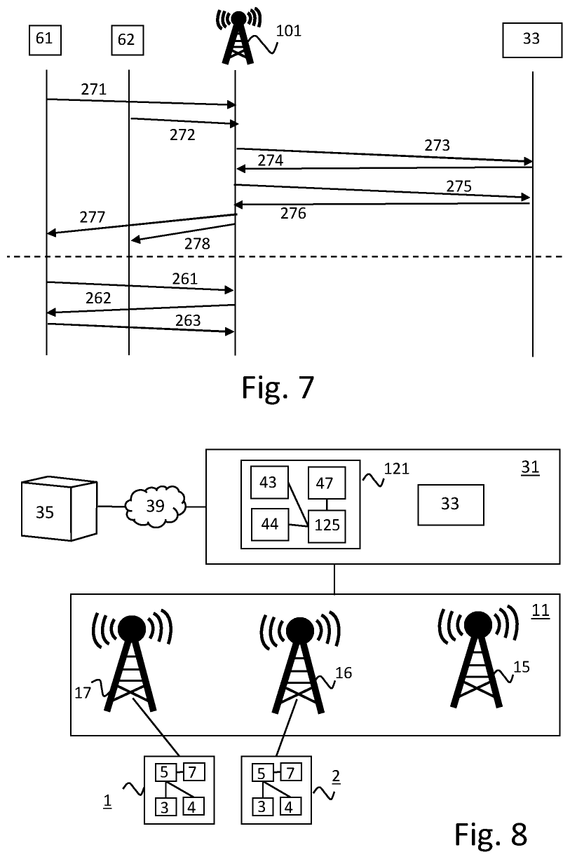

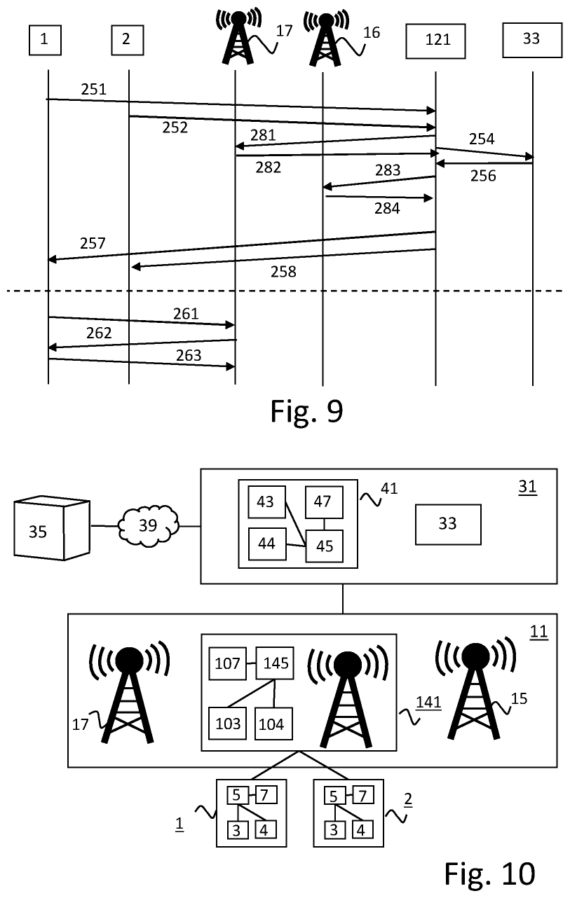

In the example of FIG. 5, device 1 performs step 261 after the data flow between device 1 and the core network has been established. In step 261, device 1 transmits a scheduling request to the base station 21. In step 262, the base station 21 transmits a scheduling grant message to the device 1. The scheduling grant message informs the device of the allocated resources. In step 263, the device I transmits data to the base station 21 over the data radio bearer associated with the data flow using the allocated resources. The device 2 will perform steps similar to steps 261 and 263 and the base station 21 will perform a step similar to step 262 in relation to the device 2. These steps are not shown in FIG. 5 (and FIGS. 7 and 9) for the sake of brevity.

FIG. 6 is a block diagram of a second embodiment of the device and a second embodiment of the system in which the system is a base station. FIG. 6 represents implementation option 1b). This implementation option addresses the case where only the base station is aware of the joint nature of the data flows and scheduling is done in a separate, per-flow manner. In this implementation option, the (admissibility of the) one or more joint quality-of-service requirements (e.g., the optimal GBR split) is directly determined by the base station based on its knowledge of radio link qualities and the cell load of the involved devices/UEs, amongst others. There is a check with the core network based on individual (i.e., data flow-specific) quality-of-service requirements (e.g., based on the derived GBR split).

In the embodiment of FIG. 6, the base station 21 of FIG. 3 has been replaced with the base station 101 and the devices 1 and 2 of FIG. 3 have been replaced with the devices 61 and 62. The devices 61 and 62 each comprise a receiver 3, a transmitter 4, a processor 65, and a memory 7. The processor 65 is configured to determine one or more quality-of-service requirements of one or more applications, e.g., at the (mobile) network level, and create a request to admit a group of at least two data flows with one or more joint quality-of-service requirements. The request specifies the one or more quality-of-service requirements of the one or more applications as the one or more joint quality-of-service requirements for which admission is requested. The group of data flows comprises the first data flow.

The processor 65 is further configured to transmit the request to the base station 101, receive, from the base station 101, a response indicating whether the request has been accepted or rejected, and transmit data to the base station 101 over the data radio bearer associated with the first data flow if the request has been accepted.

The base station 101 comprises a receiver 103, a transmitter 104, a processor 105, and a memory 107. The processor 105 is configured to receive, from the device 61 and/or the device 62, a request to admit a group of at least two data flows with one or more joint quality-of-service requirements. The request specifies the one or more joint quality of service requirements. The processor 105 is configured to determine whether the one or more joint quality-of-service requirements can be accepted, and transmit, to the device 61 and/or the device 62, a response that the request has been accepted if it is determined that the one or more joint quality-of-service requirements can be accepted or a response that the request has been rejected otherwise.

In the embodiment of FIG. 6, the processor 105 of the system 101 is configured to determine one or more individual quality-of-service requirements for each device in a group of devices based on the joint quality-of-service requirements and ask the core network system 33 whether the core network can accept the individual quality-of-service requirements.

FIG. 7 shows an example of flows transmitted by the devices depicted in FIG. 6. Compared to the flows depicted in FIG. 5, requests are transmitted in steps 271 and 272 to the base station 101 of FIG. 7 instead of in steps 251 and 252 to the (core network) system 41, as depicted in FIG. 5. Furthermore, the base station 101 does not ask the second (core network) system 33 whether the core network can accept the one or more joint quality-of-service requirements. Instead, the base station 101 first splits the one or more joint quality-of-service requirements in individual quality-of-service requirements, e.g., based on its knowledge of radio link qualities and the cell load of the involved devices/UEs, and then asks the core network system 33 whether the core network can accept the individual quality-of-service requirements for devices 61 and 62, respectively, in steps 273 and 275, respectively.

The core network system 33 informs the base station 101 whether it accepts the individual quality-of-service requirements for devices 1 and 2, respectively, in steps 274 and 276, respectively. In steps 277 and 278, a response that the request has been accepted if it is determined that the one or more joint quality-of-service requirements can be accepted or a response that the request has been rejected otherwise are transmitted by the base station 101 to the devices 61 and 62, respectively. The base station 101 then conducts packet scheduling for both data flows based on the individual (split) quality-of-service requirements.

FIG. 8 is a block diagram of the first embodiment of the device (as shown in FIG. 3) and a third embodiment of the system. FIG. 8 represents implementation option 1c). This implementation option addresses the case where only the core network 31 is aware of the joint nature of the data flows and scheduling is done in a separate, per-flow manner. In this implementation option, the (core network) system 121, e.g., the PCF in 5G, determines a suitable split of the joint quality-of-service (e.g., GBR) requirements into individual data flow-specific quality-of-service requirements and ensures that either all or none of the involved data flows (e.g., 5G QoS flows) are established.

The system 121 comprises a receiver 43, a transmitter 44, a processor 125, and a memory 47. The processor 125 is configured to receive, from the device 1 and/or the device 2 (also shown in FIG. 3), a request to admit a group of at least two data flows with one or more joint quality-of-service requirements. The request specifies the one or more joint quality of service requirements. The processor 125 is configured to determine whether the one or more joint quality-of-service requirements can be accepted, and transmit, to the device 1 and/or the device 2, a response that the request has been accepted if it is determined that the one or more joint quality-of-service requirements can be accepted or a response that the request has been rejected otherwise.

In the embodiment of FIG. 8, the processor 125 of the system 121 is configured to determine one or more individual quality-of-service requirements for each device in a group of devices based on the one or more joint quality-of-service requirements and ask the base station 21 whether the base station can accept the individual quality-of-service requirements for the group of devices. The group of devices comprises the device from which the request was received. In the example of FIG. 8, the group of devices comprises devices 1 and 2.

In 5G, the system 121 is typically the PCF. The PCF is in control of QoS flows and decides whether the requested GBR is allowed. For this decision, the PCF checks with the gNB via the SMF (for RAN admission control) and checks with UPF via the SMF (for core network admission control). Conventional UPFs will either accept or reject the QoS flow request (depending on the resources availability/capabilities in the core network). Conventional gNBs may be able to use QoS Notification control to revise the request in case the requested QoS cannot be fulfilled due to resource limitations/capabilities at the gNB.

For example, system 121 may successively attempt a number of GBR splits and request admission both in the RAN and the core network, until a split is found for which all data flows are admitted by both RAN and core network. If no such split is found, the core network function rejects the establishment of both data flows.

In the ‘trial and error’ approach of finding an acceptable split, system 121 may optionally request some information from the base stations 16 and 17 that is indicative of e.g., the relative radio link qualities of the involved devices/UEs in order to aid in more quickly finding an optimal split. This may be used instead of or in addition to the above-mentioned QoS Notification control.

In the embodiment of FIG. 8, devices 1 and 2 connect to different base stations, e.g., to distributed units that do not share a common centralized unit in a C-RAN architecture or different base stations in a traditional non-C-RAN architecture, without it being necessary for the different base stations to coordinate in this embodiment. In the example of FIG. 8, device 1 connects to base station 17 and device 2 connects to base station 16. Alternatively, devices 1 and 2 may connect to the same base station, e.g., to the same or to different distributed units that do share a common centralized unit in a C-RAN architecture.

FIG. 9 shows an example of flows transmitted by the devices depicted in FIG. 8. Compared to the flows shown in FIG. 5, steps 253 and 254 have been replaced with steps 281-284, because devices 1 and 2 are connected to different base stations. Even if devices 1 and 2 would be connected to the same base station 16 or 17, the same steps 281-284 would need to be performed, because base stations 16 and 17 are not aware of the concept of joint quality-of-service requirements.

In step 281, the system 121 asks the base station 17 whether the base station can accept the individual (split) quality-of-service requirements for device 1. The base station 17 transmits its response in step 282. In step 283, the system 121 asks the base station 16 whether the base station can accept the individual (split) quality-of-service requirements for device 2. The base station 16 transmits its response in step 284. As described above, steps 281-284 and steps 254 and 256 may be performed several times to find acceptable individual quality-of-service requirements, i.e., an acceptable split.

FIG. 10 is a block diagram of the first embodiment of the device (as shown in FIG. 3), the first embodiment of the system (as shown in FIG. 3), and a first embodiment of the base station. FIG. 10 represents implementation option 2a). This implementation option addresses the case where both the base station and the core network are aware of the joint nature of the data flows and scheduling is done in a joint manner. In this implementation option, the core network can remain in charge of the data flow establishment.

The system 41 and the devices 1 and 2 are the same in this embodiment as in the embodiment of FIG. 3. However, the base station 21 of FIG. 3 has been replaced with a base station 141. The flows shown in FIG. 5 in relation to the embodiment of FIG. 3, and the admission control described in relation to this embodiment, also apply to the embodiment of FIG. 10 with the base station 21 being replaced by the base station 141. Base stations 15 and 17 are the same in the example of FIG. 10 as in the example of FIG. 3, but they may alternatively be replaced with base stations that are configured in the same way as base station 141.

The base station 141 comprises a receiver 103, a transmitter 104, a processor 145, and a memory 107. The processor 145 is configured to receive a scheduling request from device 1 or device 2 requesting the base station 141 to allocate resources for transmitting data from the device to the base station 141 over a data radio bearer associated with a data flow. The data flow is associated with a group of at least two data flows for use by a group of devices. The group of data flows has been assigned one or more joint quality-of-service requirements. In the example of FIG. 10, the group of devices includes devices 1 and 2.

The processor 145 is configured to allocate the resources to the device based on the joint quality-of-service requirements and transmit a scheduling grant message to the device. The scheduling grant message informs the device of the allocated resources.

For example, a joint 100 Mb/s GBR requirement could be satisfied by the base station 141 scheduling the devices/UEs such that the sum of their experienced throughputs exceeds the 100 Mb/s GBR, rather than managing them individually and with rigid individual sub-targets of x Mb/s and (100−x) Mb/s, respectively.

The devices/UEs 1 and 2 are the same in the embodiment of FIG. 10 as in the embodiment of FIG. 3. In order for the splitter 83 to optimally take advantage of the joint quality-of-service-based scheduling by the base station 21, the splitter 83 may be configured to determine a size of a first queue associated with a first data flow used by device 1, determine a size of a second queue associated with the second data flow used by device 2, and select a queue from a plurality of queues based on at least the sizes of the first queue and the second queue.

The plurality of queues comprises the first queue and the second queue. The group of data flows comprises the first data flow and the second data flow. The first queue is preferably associated only with the first data flow and the second queue is preferably associated only with the second data flow, but the first queue may also be associated with all data flows of device 1 and the second queue may be associated with all data flows of device 2, for example. The splitter 83 is then further configured to add a new data packet to the selected queue.

Thus, when the scheduler of the base station 141 decides to grant more resources to device 1 than to device 2, this may result in a higher experienced device throughput for device I than for device 2, in which case the splitter 83 observes that the first queue associated with device 1 is emptied more quickly than the second queue associated with device 2 and hence needs to be fed more quickly and therefore adds a new data packet to the first queue instead of to the second queue.

The splitter 83 may also be configured in the above-described way if there is no joint quality-of-service-based scheduling by the base station, as described in relation to the embodiments of FIGS. 3, 6, and 8. In any case, the splitter 83 of FIG. 4 needs to appropriately feed the two queues.

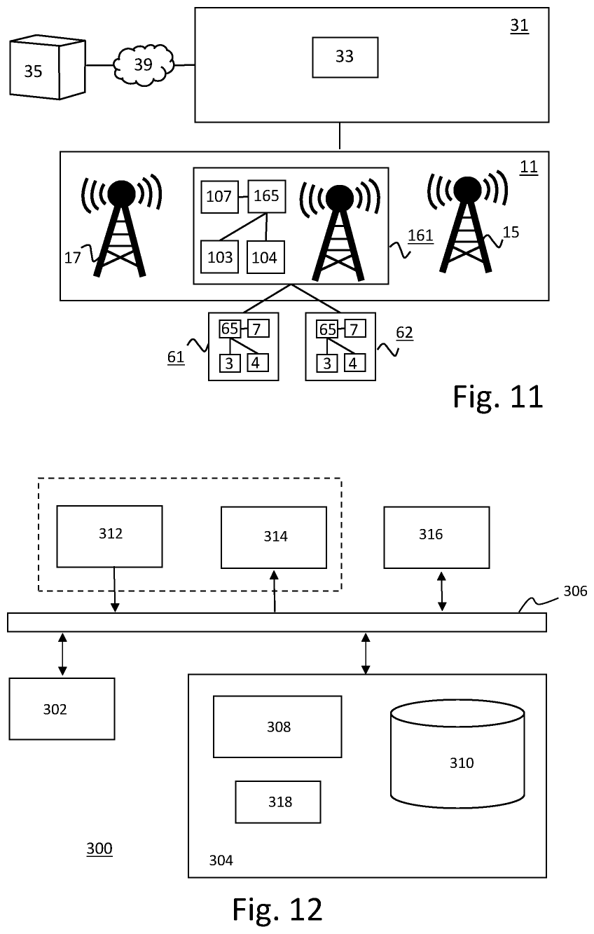

FIG. 11 is a block diagram of the second embodiment of the device (as shown in FIG. 6) and a second embodiment of the base station and a fourth embodiment of the system, in which the base station is the system. FIG. 11 represents implementation option 2b). This implementation option addresses the case where only the base station is aware of the joint nature of the data flows and scheduling is done in a joint manner. In this implementation option, the joint admissibility of the data flows is determined by the base station from a RAN perspective and also verified with the core network to cover the core network perspective.

For the latter check, the base station could first split the joint quality-of-service requirements in individual quality-of-service requirements like in the embodiment of FIG. 6., e.g., based on its knowledge of radio link qualities and the cell load of the involved devices/UEs. Once admitted by the core network, the base station may ignore these individual quality-of-service requirements and conduct packet scheduling for both data flows based on the joint (unsplit) quality-of-service requirements.

The base station 161 comprises a receiver 103, a transmitter 104, a processor 165, and a memory 107. The processor 165 is configured in a similar way as the processor 105 of the base station 101 of FIG. 6 with respect to quality-of-service management and configured in a similar way as the processor 145 of the base station 141 of FIG. 10 with respect to scheduling. The flows shown in FIG. 7 in relation to the embodiment of FIG. 6, and the admission control described in relation to this embodiment, also apply to the embodiment of FIG. 10 with the base station 101 being replaced by the base station 161.

While the above description of FIGS. 1 to 11 provides examples in which the applications are characterized by a GBR requirement, the basic principles and implementation options also apply for applications that are characterized by a reliability/latency requirement, where e.g., 99.9999% of all frames, packets or transport blocks need to be successfully transferred within some latency budget. In embodiments where a joint QoS requirement is split into flow-specific QoS requirements, rather than an ‘additive requirement split’, as is the case for Enhanced Mobile Broadband-type (eMBB-type) applications with GBR requirements, a ‘multiplicative requirement split’ may apply for Ultra Reliability and Low Latency Communication-type (URLLC-type) applications with reliability/latency requirements.

For example, in a scenario where block transmissions are duplicated via both data flows, a 99.9999% reliability requirement may be split into two data flow-specific requirements for 99.9% reliability, noting that 0.999999=1−(1−0.999)². Or, alternatively, no such split in reliability requirements is applied, but a common reliability requirement is targeted in a joint management of the two established data flows.

In the embodiments shown in FIGS. 3, 6, 8, 10, and 11, the devices 1-2 and 61-62 comprise one processor 5 or 65. In an alternative embodiment, one or more of the devices 1-2 and 61-62 comprise multiple processors. The processors 5 and 65 may be general-purpose processors, e.g., ARM or Qualcomm processors, or application-specific processors. The processors 5 and 65 may run Google Android or Apple IOS as operating system, for example.

The receiver 3 and the transmitter 4 of the devices 1-2 and 61-62 may use one or more wireless communication technologies such as Wi-Fi, LTE, and/or 5G New Radio to communicate with base stations, for example. The receiver 3 and the transmitter 4 may be combined in a transceiver. The devices 1-2 and 61-62 may comprise other components typical for a device, e.g., a battery and/or a power connector.

The devices 1-2 and 61-62 of FIGS. 3, 6, 8, 10, and 11 are preferably mobile devices. A mobile device may also be referred to by those skilled in the art as a mobile station (MS), a subscriber station, a mobile unit, a subscriber unit, a wireless unit, a wireless terminal, a wireless device, a wireless communications device, a remote device, a mobile subscriber station, an access terminal (AT), a mobile terminal, a user equipment (UE), a remote terminal, a handset, a terminal, a user agent, a mobile client, a client, or some other suitable terminology.

In the embodiments shown in FIGS. 3, 8, and 10, the systems 41 and 121 comprises one processor 45 or 125. In an alternative embodiment, the systems 41 and 121 comprise multiple processors. The processor may be a general-purpose processor, e.g., an Intel or an AMD processor, or an application-specific processor, for example. The processor may comprise multiple cores, for example. The processor may run a Unix-based or Windows operating system, for example. The memory 47 may comprise solid state memory, e.g., one or more Solid State Disks (SSDs) made out of Flash memory, or one or more hard disks, for example.

The receiver 43 and the transmitters 44 may use one or more communication technologies (wired or wireless) to communicate, for example, with other systems in the RAN or in the core network. The receiver and the transmitter may be combined in a transceiver. The systems 41 and 121 may comprise other components typical for a network unit in a mobile communication network, e.g., a power supply.

In the embodiments shown in FIGS. 3, 6, 8, 10, and 11, each of the base stations may comprise a single unit or a central unit and one or multiple distributed units, for example.

In the embodiments shown in FIGS. 6, 10, and 11, the base stations 101, 141, and 161 comprise one processor. In an alternative embodiment, one or more of the base stations 101, 141, and 161 comprise multiple processors. The processor of the base stations 101, 141, and 161 may be a general-purpose processor, e.g., an Intel or an AMD processor, or an application-specific processor, for example. The processor may comprise multiple cores, for example. The processor may run a Unix-based or Windows operating system, for example. The memory 107 may comprise solid state memory, e.g., one or more Solid State Disks (SSDs) made out of Flash memory, or one or more hard disks, for example.

The receiver 103 and the transmitter 104 may use one or more wireless communication technologies such as Wi-Fi, LTE, and/or 5G New Radio to communicate with devices 1-2 and 61-62, for example. The receiver 103 and the transmitters 104 may use one or more communication technologies (wired or wireless) to communicate with other systems in the RAN or in the core network, for example. The receivers and the transmitter may be combined in a transceiver. The base stations may comprise other components typical for a component in a mobile communication network, e.g., a power supply.

FIG. 12 depicts a block diagram illustrating an exemplary data processing system that may perform the method as described with reference to FIGS. 1, 2, 5, 7, and 9

As shown in FIG. 12, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the number of times program code must be retrieved from the bulk storage device 310 during execution.

Input/output (I/O) devices depicted as an input device 312 and an output device 314 optionally can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 12 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 12, the memory elements 304 may store an application 318. In various embodiments, the application 318 may be stored in the local memory 308, he one or more bulk storage devices 310, or separate from the local memory and the bulk storage devices. It should be appreciated that the data processing system 300 may further execute an operating system (not shown in FIG. 12) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising.” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope of the present invention. The embodiments were chosen and described in order to best explain the principles and some practical applications of the present invention, and to enable others of ordinary skill in the art to understand the present invention for various embodiments with various modifications as are suited to the particular use contemplated.

1. A device for transmitting data over a data radio bearer associated with a first data flow, the device comprising at least one processor configured to:
determine one or more quality-of-service requirements of one or more applications,
create a request specifying the one or more quality-of-service requirements to admit a group of at least two data flows with one or more joint quality-of-service requirements, the group of data flows comprising the first data flow,
transmit the request to a system for establishing data flows,
receive, from the system for establishing data flows, a response indicating whether the request has been accepted or rejected, and
transmit data to a base station over the data radio bearer associated with the first data flow if the request has been accepted.

2. A device as claimed in claim 1, wherein the request comprises device identifiers of devices in a group of devices, the group of devices comprising the device.

3. A device as claimed in claim 1, wherein the request comprises a flag, the flag uniquely identifying the group of data flows and/or a group of devices.

4. A device as claimed in claim 1, wherein the request to admit the group of data flows comprises a request to establish the first data flow.

5. A device as claimed in claim 1, wherein the at least one processor is further configured to create a further request to establish the first data flow and transmit the further request to the system for establishing data flows before transmitting the data to the base station.

6. A system comprising the device of claim 1 and a further device, the further device being configured to transmit further data to the base station over a further data radio bearer associated with a second data flow, the group of data flows comprising the second data flow, wherein the system is configured to:
determine a size of a first queue associated with the first data flow,
determine a size of a second queue associated with the second data flow,
select a queue from a plurality of queues based on at least the sizes of the first queue and the second queue, the plurality of queues comprising the first queue and the second queue, and
add a new data packet to the selected queue.

7. A system for establishing data flows, the system comprising at least one processor configured to:
receive, from a device, a request to admit a group of at least two data flows with one or more joint quality-of-service requirements, the request specifying the one or more joint quality of service requirements,
determine whether the one or more joint quality-of-service requirements can be accepted, and
transmit, to the device, a response that the request has been accepted if it is determined that the one or more joint quality-of-service requirements can be accepted or a response that the request has been rejected otherwise.

8. A system as claimed in claim 7, wherein the at least one processor is configured to determine one or more individual quality-of-service requirements for each of the devices in a group of devices based on the one or more joint quality-of-service requirements and ask the base station whether the base station can accept the individual quality-of-service requirements for the group of devices.

9. A system as claimed in claim 7, wherein the at least one processor is configured to ask the base station whether the base station can accept the one or more joint quality-of-service requirements for the group of devices.

10. A system as claimed in claim 7, wherein the request to admit the group of data flows comprises a request to establish a first data flow from the group of data flows and the at least one processor is configured to establish the first data flow if it is determined that the one or more joint quality-of-service requirements can be accepted.

11. A base station for allocating resources for transmitting data from a device to the base station over a data radio bearer associated with a data flow, the base station comprising at least one processor configured to:
receive a scheduling request from the device, the scheduling request requesting the base station to allocate resources for transmitting data from the device to the base station over the data radio bearer associated with the data flow, the data flow being associated with a group of at least two data flows for use by a group of devices, the group of data flows having been assigned one or more joint quality-of-service requirements,
allocate the resources to the device based on the one or more joint quality-of-service requirements, and
transmit a scheduling grant message to the device, the scheduling grant message informing the device of the allocated resources.

12. A method of transmitting data over a data radio bearer associated with a data flow, the method comprising:
determining one or more quality-of-service requirements of one or more applications,
creating a request specifying the one or more quality-of-service requirements to admit a group of at least two data flows with one or more joint quality-of-service requirements, the group of data flows comprising the first data flow;
transmitting the request to a system for establishing data flows,
receiving, from the system for establishing data flows, a response indicating whether the request has been accepted or rejected; and
transmitting data to a base station over the data radio bearer associated with the first data flow if the request has been accepted.

13. A method of establishing data flows, the method comprising:
receiving, from a device, a request to admit a group of at least two data flows with one or more joint quality-of-service requirements, the request specifying the one or more joint quality of service requirements;
determining whether the one or more joint quality-of-service requirements can be accepted; and
transmitting, to the device, a response that the request has been accepted if it is determined that the one or more joint quality-of-service requirements can be accepted or a response that the request has been rejected otherwise.

14. A method of allocating resources for transmitting data from a device to a base station over a data radio bearer associated with a data flow, the method comprising:
receiving a scheduling request from the device, the scheduling request requesting the base station to allocate resources for transmitting data from the device to the base station over the data radio bearer associated with the data flow, the data flow being associated with a group of at least two data flows for use by a group of devices, the group of data flows having been assigned one or more joint quality-of-service requirements;
allocating the resources to the device based the one or more joint quality-of-service requirements; and
transmitting a scheduling grant message to the device, the scheduling grant message informing the device of the allocated resources.

15. A computer program or suite of computer programs comprising at least one software code portion or a computer program product storing at least one software code portion, the software code portion, when run on a computer system, being configured for performing the method of claim 12.
